(19) United States
(12) Patent Application Publication
(10) Pub. No.: US 2006/0224719 A1
(43) Pub. Date: Oct. 5, 2006

(54) OPERATOR SIMULATOR AND NON-INVASIVE INTERFACE ENGINE

(75) Inventors: Kapali Eswaran, Alpharetta, GA (US); Ashleh Kulkarni, Alpharetta, GA (US)

Correspondence Address: SMITH FROHWEIN TEMPEL GREENLEE BLAHA, LLC, P.O. BOX 88148, ATLANTA, GA, 30356, US

(73) Assignee: INTEGRATED INFORMATICS, INC., Roswell, GA (US)

(21) Appl. No.: 10/907,339

(22) Filed: Mar. 30, 2005

(51) Int. Cl. G06F 15/173

(52) U.S. Cl. 709/224

(57) ABSTRACT

Information and data that is created, stored and operated on by various systems may be necessary for other systems but may not be readily attainable. A non-invasive interface engine is introduced that allows the data among various systems to be freely shared without the need for creating expensive and customize programs to perform data conversion or requiring the suppliers of the various system to modify the systems. The non-invasive interface engine can be interposed between processes that communicate with each other. By acting as a pass through agent, the engine can capture data from one system and provide the data to another system. This data can be reformatted and pushed to other systems, can be made available for other systems to access, or may be entered into other systems by creating script files that emulate an operator entering data into the other systems.

### BACKGROUND OF THE INVENTION

The health industry has been the instigating factor for much technological advancement. Most of these technological advancements have focused on techniques, pharmaceuticals, monitoring equipment and surgical advancements. However, as is the case in many other industries, the health care industry is well entrenched into the computer age. This is true even in the healthcare information industry operating within hospitals and physician offices. Thus, for the past several years, it has been a very common sight, upon visiting a hospital or a physician's office, to witness several computer systems that have been installed and are operational for various tasks including setting up appointments, managing the accounting, tracking patient information, obtaining/order prescriptions etc.

As the employed technology within health care establishments has advanced, many different systems and components have been introduced, most of which need to gain access to data from other systems in an electronic format. However, because different systems have been developed by different vendors, it is often the case that the data that has been manually entered and verified in one system is not readily accessible to another system. For instance, a patient information data base may include pertinent information about a patient's medical history. Such information would be greatly beneficial to another system that processes pharmaceutical prescriptions. Absent the ability to access this information directly across the various platforms, it is difficult and cumbersome to get or put data from these systems in electronic format without considerable efforts and more often without cooperation of the vendors who had developed these systems. One option for sharing such information between systems includes developing custom programs that can extract data from a source system, reformat the data as required for a target system and then load that data into the target system. This of course assumes that the source system provides external access to the data and the target system provides a mechanism for transferring the data into the target system. Another option is simply to offer a human operator interface that allows operators to read the data out of the source system and manually enter the data into the target system. Both of these options are inefficient, error-prone and costly. Thus, in an environment that utilizes several different systems, the costs and risks associated with such a task are unacceptable.

As governmental, technological and marketing needs change, the need to have access to a shared pool of such information, especially in the health care industry, increases. For instance, in many circumstances there is a need to take certain actions based on the value of the data that is retrieved from a system or stored into a system at the time when the data is retrieved or stored. Such information can initially be provided through operator data entry, or more recently through the use of bar code scanning. For instance, hospital patients generally have an ID tag bracelet that includes a bar code. As medications are administered, procedures performed or vital statistics are checked, this bar code is scanned and additional data entry associated with the patient is performed. This information can be crucial to other systems. Thus, there is a need for a solution that will non-invasively capture the flow of the operator interactions with a computer system in real-time and allow this data to be shared or imported into other systems.

Not only is it important to capture data in real-time and share this data among various systems, there is also a need to be able to transfer data between systems or access data in other systems in an electronic format. Such a capability greatly reduces the errors that can be introduced during a manual data entry process. However, this requirement is greatly impeded by the fact that system manufactures often use proprietary, or at the least, incompatible data formats for storing such information. Thus, there is a need in the art for a technique that enables the transfer and/or sharing of data between various systems without being limited by the various data storage or structure techniques, and basically is data format independent. Such a technique would not require the cooperation of the developers of the systems.

As previously mentioned, the technique used in the past to address this need in the art requires the cooperation of the developers of the system. Thus, equipment users can employ the use of various vendors to help address these needs in the market. However, such a solution is cost prohibitive, can require several custom programs to be developed and maintained, and is subject to the necessity of determining the format in which data is stored on the various systems.

To further illustrate this need in the art, the technological framework for current systems is briefly described. Computers in a network have a unique address called an IP Address. To communicate, a computer uses one of the many ports that are available to it. For instance, if you think of a computer as a house, the street address of the house will be its IP Address. The front door will correspond to a port, a back door will correspond to another port, and a side door will correspond yet another port.

FIG. 1 is a block diagram illustrating a typical communication configuration between two systems interconnected over a network. System 110, running a front-end process 112 communicates with system 120 which is running a back-end process 122. The front-end process 112 may be a thin-client or a thick-client application. Thin-client applications may simply consist of commands that are sent to the second system using a browser, such as Netscape or Internet Explorer, or may be computer programs that are rather very small in size and consume relatively little computing power (storage and CPU) of the first system. Thick-client applications are computer programs, other than browsers, that reside and execute on a system and consume substantially more computing power than would a browser based application.

The thick or thin client applications running on the first system, communicate with an application running on the second system using a connection. In typical operation, a back-end process will communicate with multiple front-end applications or processes but, for simplicity, only one such front-end process is illustrated. The back-end process 122 publishes the port number over which it will communicate with a front-end process 112. When the front-end process 112 wants to establish a connection with the back-end process 122, it needs to know the socket address for the back-end process 122. The socket address includes the IP Address associated with system 120 and the port number through which the back-end process 122 communicates. To establish communication, the front-end process 112 sends a message using any available port in computer 110 to the socket address of the back-end process 122 requesting communication with the back-end process. This message includes the socket address of the front-end process 112. The back-end process 122 accepts the request from the front-end process 112 and sends the acceptance message to the socket address of the front-end process 112. Once a connection is thus established between the front-end process 112 and the back-end process 122, other messages are sent over this connection until either of the processes drop the connection.

Because the socket address of the back-end process 122 may not be a fixed address and may not be known ahead of time, the socket address of the back-end process 122 often is a settable parameter to the front-end process 112; however, in some circumstances it can be hard-coded or automatically detected. For instance, the front-end process 112 is commonly coded to fetch and use the socket address of the back-end process 122 from a file or a table that is easily changeable at the time the front-end process is installed on system 110. For example, assume that the IP address of system 120 is 192.180.111.40 and that the back-end process expects communications to be received through the port 9101. Further, assume that the front-end process 112 is installed on system 110 with an IP address of 192.180.111.51 and that the front-end process 112 will use port 5301 on system 110 for communicating with the back-end process 122. The socket address of the back-end process 122 is {<192.180.111.40>, 9101}. When the front-end process 112 requests for communication with the back-end process 122, it sends the request for communication to this socket along with his socket address, namely {<192.180.111.51>, 5301}. The operating system in computer 110 allocated the port that the front end process will use. This is not fixed to a specific value.

The back-end process 122 can be moved to another system, or it may be decided that the back-end process 122 will reside in the same system, but use a different port. To accommodate these changes, the socket address to which the front-end process 112 should communicate to the back-end process 122 should be an easily modifiable parameter of the front-end process 112. This is commonly the case and as mentioned earlier, the front-end process 112 is usually coded to fetch and use the socket address of the back-end process 122 from a file or a table that is easily changeable at the time the front-end process is installed on system 110. The front-end and back-end systems are components of the same application system.

A logical communication path is established after the initial request from the front-end process 112 running on system 110 is made to the back-end process 122 running on system 120 and the back-end process 122 accepts the request. The front-end process 112 sends a request over a socket in system 110 to a socket on system 120. Two sockets define a connection, which is the communication path. Another instance of the same front-end process 112 running on another system will communicate with the back-end process running on system 120 over another connection. A socket and connection are bi-directional. Thus, information can be sent and received over the socket. A connection is between a From-Socket and To-Socket. For purposes of discussion, the socket through which the connection is requested is referred to as the From-Socket and the other socket is the To-Socket. The backend process 122 communicates with multiple instances of the front-end processes by creating a new thread or a child process for every front-end request. This way each front-end process has its own connection to the back-end process for passing data back and forth.

In many situations, the environment for which an application was originally designed changes. For example, consider a registration application that a healthcare worker in a hospital may use for entering registration information (demographics, insurance and initial diagnosis) for a new patient. The registration application may include various formatting screens for editing and entering the patient data. The registration application may also include business logic defining what information is to be stored and restored, as well as a database storage function for defining how the information is stored. Applying this registration application example to FIG. 1, the front-end process 112 may be a thick client application running on system 110. The front-end process 112 provides various screens to the operator for the entry and editing of input data. The front-end process 112 may also perform presentation of the registration data in a user-friendly manner. The front-end process 112 interacts with the other layers of the registration application that reside in the back-end process 122 (i.e., business logic and the database) running on system 120. The front-end process 112 and the back-end process communicate over a connection 101 that consists of socket 124 and socket 114.

FIG. 2A is a block diagram illustrating a typical communication configuration between three systems interconnected over a network. In this configuration, two users are running two instances of the same thick client front-end process. One instance of the front-end process 212 is running on system 210 and the other instance 232 is running on system 230. The front-end process 212 on system 210 and the back-end process 222, executing on system 220, communicate over a connection shown as 201. The front-end process 232 running on system 230 and the back-end process 222 running on system 220 communicate over a connection shown as 202. The back-end process 222 is communicating via two connections using the same socket 224 in system 220 using two threads.

The connections shown in FIGS. 1 and 2A are logical connections. Physically the systems 210, 220 and 230 may reside on a local area network as illustrated in FIG. 2B or they may be a part of a wide area network.

A problem in the industry is realized under the following scenario. Assume that the registration application discussed in conjunction with FIGS. 1, 2A and 2B has been installed and has been operational for a period of time at a particular site. Subsequently, a new healthcare regulation is passed which imposes a requirement that if a newly admitted patient is initially diagnosed with Tuberculosis, the Public Health Agency must be notified of the registration information. Suppose the regulation also provides specifics as to the format in which the information is to be reported. To meet these requirements, the hospital must purchase and install a new system that functions to inform the Public Health Agency of this information in a format that has been specified by the Public Health Agency. In order to accomplish this task the new system will need access to the registration information.

One way to provide the registration information to the new system is to have an operator physically key in the registration information into the new system. Thus, the operator(s) will then be required to not only key this information into the existing systems, but will also be required to repeat this process with the new system. This creates additional overhead expenses for the institution, as well as increases the chances for operator error.

Another way is to provide the registration information to the new system is for the new system to access the database of existing systems and import this information. Such a technique would require the new system to have knowledge of how the data is stored in the existing systems, as well as technical information of how to access the information within the existing systems. Thus, this technique is only viable if the knowledge of the data format and the access information is available. However, vendors typically view this as proprietary information and in most situations, the information is not available. In addition, the cost for extracting, reformatting and importing this information can result in considerable cost to the institution.

FIG. 3 is a block diagram illustrating another technique that can be employed for providing/sharing information between systems. In this configuration, an existing system 310 can send the registration information to the new system 320 in a message utilizing some standard e-formats. Such standard e-formats that are commonly used include XML and HL7. However, such standards, although promulgated as standards, are not universal in that vendors implement variations of these standards. Thus, the message format from the existing system 310 may be in a slightly different format than what is expected by the new system 320. To manage these variations and to make sure that the messages that are sent out and indeed received, intermediate systems known commonly referred to as interface engines 330 are employed. In this example, when interface engine 330 receives a message from an existing system 310, the interface engine 330 stores the message in internally. The interface engine 330 then sends acknowledgement of the receipt of the message to the existing system 310. The interface engine 330 then checks to see whether the message is to be sent to the new system 320. If the message is to be sent, the interface engine 330 re-formats the message, if necessary, to the specifications provided for the new system 320. The interface engine 330 then sends the re-formatted message to the new system 320. The interface engine 330 then waits for the acknowledgement from new system 320. Once the acknowledgement is received by the interface engine 330, it deletes the message from its internal storage. Thus, the interface engine 330 operates as an intermediary and the existing system 310 and the new system 320 do not communicate directly with each other. The interface engine 330 includes logic pertaining to the actions that are to be taken when a message is received. Examples of such actions include determining whether or not to store a message, the destinations to which the message is to be sent, and the format translations that are to be applied to the message. Such interface engines offer an invasive approach to exchange data in the sense that the underlying systems need be modified to send and receive messages in an agreed up on e-formats. For example, when such an interface engine is used in a hospital healthcare systems environment, underlying systems such as a Laboratory Information System that manages laboratory results and an ADT System that manages patient admissions need be modified or equipped to exchange messages in HL7 formats. It is also to be observed that such interface engines interface with whole application systems and not with sub-components of application systems. In the healthcare information systems environment, for example, an ADT system as a whole interfaces to an interface engine and not the individual components of the ADT system.

Using this technique, when the translation rules are not self-evident or are not publicly available, cooperation from vendors of the existing system 310 and the new system 320 is required. Furthermore, the information system departments of the companies in which these systems are installed typically perform the maintenance of the interface engine code. These departments are often overloaded with maintaining the interface engine to keep up with changes of new releases of existing systems. Maintenance of the interface engine 330 then becomes a bottleneck. Thus, once a company purchases one system from a selected vendor, to alleviate the complexities of system interfacing, the company may be forced into an unpleasant situation of having to purchase all additional systems from the same vendor. This can be a great disadvantage to a company in that the company loses the ability to negotiate or shop for competitively priced equipment, and may have to sacrifice desired features that may be available from a competing vendor.

Thus, for the techniques that are currently employed in the state of the art, a new system can obtain necessary information by either (a) having the operators key-in the data into new system, (b) providing access to the database of an existing system or (c) having an existing system and new system communicate using messages often through an intermediary interface engine. Each of these techniques is deficient for one or more of the above-listed reasons and thus, there is a need in the art for a solution that, among other things, alleviates these short-comings in the art.

### BRIEF SUMMARY OF THE INVENTION

The present invention addresses the above-identified needs in the art, as well as other needs in the art described in the detailed description or that are apparent to those skilled in the art by providing a non-invasive interface engine methodology that is operable to serve as an intermediary between various systems. One aspect of the present invention is to receive the flow of data and information between the front-end process and the back-end process of a first system, and store that data for use by other systems. Another aspect of the present invention is to convert the data and information from the first system into a format that is compatible with the other systems. Another aspect of the present invention is to provide the converted information to one or more other systems in either an autonomous fashion or in response to a request for the information. Another aspect of the present invention is to analyze the data and information flow between the front-end and back-end process of the first system to identify any actions that should be performed by other systems, as well as any information or warnings that should be provided to the other systems. The data and the flow being analyzed typically consists of the information, operations, data, etc. that normally travels between a front-end process and a back-end process rather special e-standard messages; however, such special e-standard messages could also be monitored and analyzed.

In one embodiment of the present invention, the information and data flow between the front-end and back-end processes of a first system is analyzed to identify scripting commands and responses. Based on this information, scripting files for performing various functions can be generated. By executing the scripting files, an operator of a system can be emulated. Advantageously, this aspect of the present invention enables data to be shared among various systems by receiving the data from a first system, generating a script for a second system, and entering the data into the second system by executing the script and thereby emulating an operator's actions for entering the data.

In another embodiment of the present invention, the information and data flow between the front-end and back-end process of a first system are captured and analyzed. If a triggering event is discovered in the analyzed information and data flow, information, warnings or alerts can be provided to one or more additional systems. In conjunction with this embodiment of the present invention, the information can be converted into a format compatible with the one or more additional systems and provided to those systems. Alternatively, the information can be converted and stored and made available for other systems that may request the information.

In yet another embodiment of the present invention, an intermediary may operate as an information source for sharing data between various systems. The intermediary may include scripts for interfacing with the various systems. If a first system desires information from a second system, the intermediary can emulate an operator of the second system to extract the desired information and then provide the extracted information to the first system.

These aspects and advantages of the present invention, as well as other aspects and advantages are described more fully in the detailed description and claims that follow.

### BRIEF DESCRIPTION OF THE SEVERAL VIEWS OF THE DRAWING

FIG. 1 is a block diagram illustrating a typical communication configuration between two systems interconnected over a network.

FIG. 2A is a block diagram illustrating a typical communication configuration between three systems interconnected over a network.

FIG. 2B is a block diagram illustrating a typical communication configuration between three systems interconnected over a LAN.

FIG. 3 is a block diagram illustrating another technique that can be employed for providing/sharing information between systems.

FIG. 4 is a block diagram illustrating the employment of the present invention within the environment illustrated in FIG. 1.

FIG. 5 is a block diagram illustrating two instances of a front-end process running on two different systems communicating with the same back-end system.

FIG. 6 is a block diagram of an environment that does not employ the present invention for the sharing of data.

FIG. 7 is a block diagram that incorporates aspects of the present invention to solve problems associated with the configuration of FIG. 6.

FIG. 8 is a block diagram illustrating the interaction of a PIS and a POS for maintaining and issuing prescriptions.

FIG. 9 is a block diagram illustrating the incorporation of aspects of the present invention to alleviate the problems with regards to sharing information between the PIS and POS scenario.

FIG. 10 is a block diagram incorporating aspects of the present invention to alleviate the problems associated with the incorrect entry of data across the PIS and POS platforms situation.

FIG. 11 is a flow diagram illustrating the steps involved in defining or creating a script for the script driven engine.

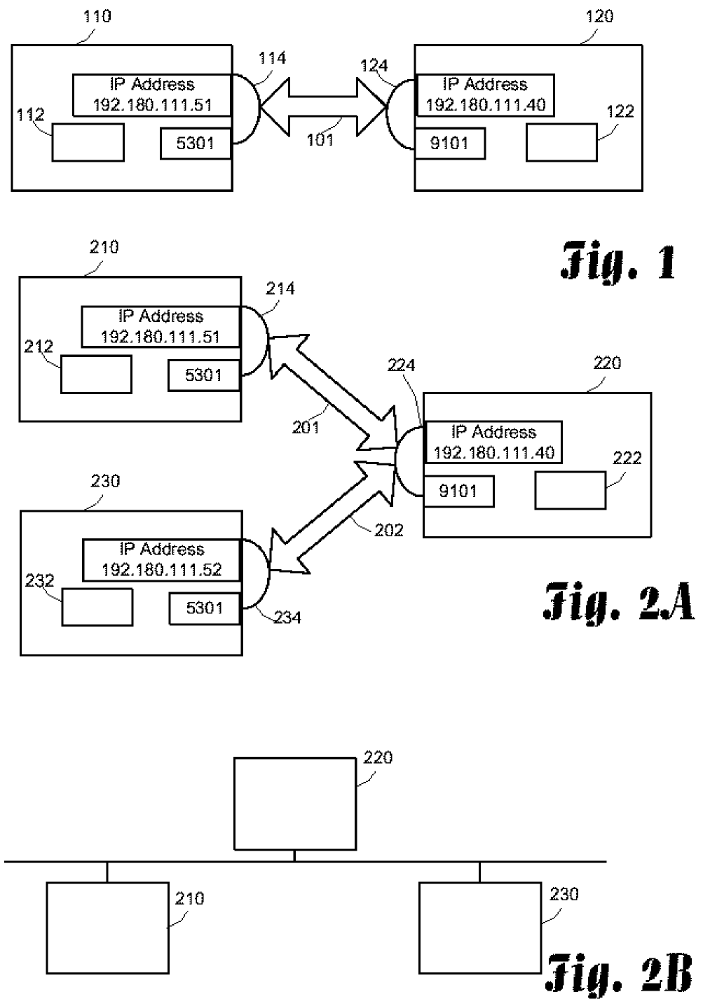

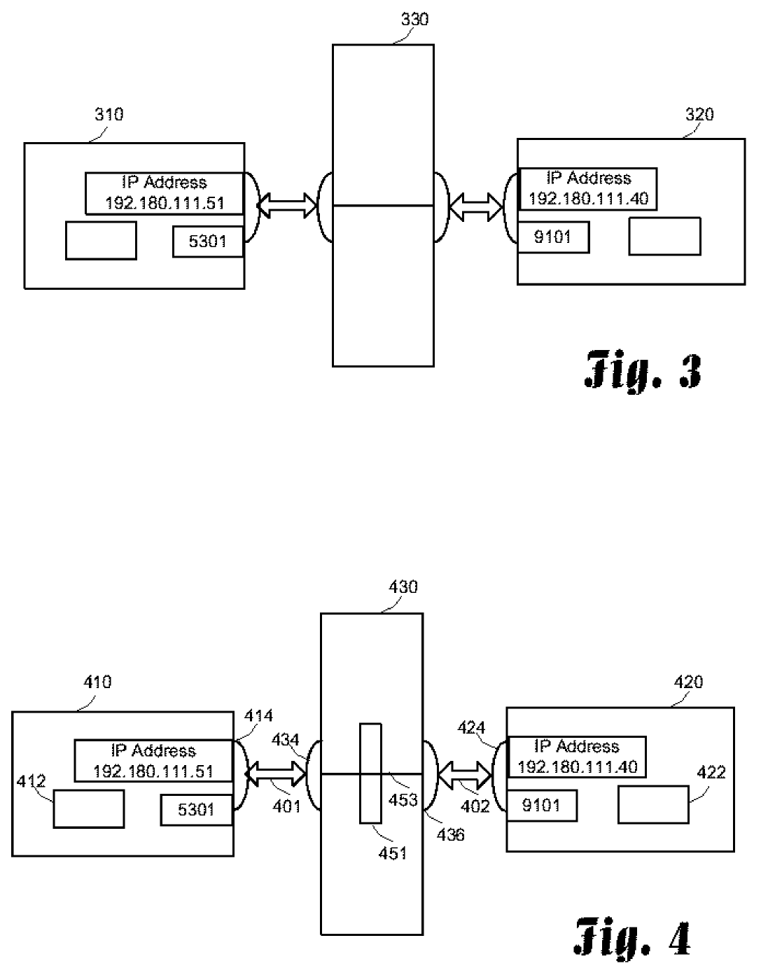

### DETAILED DESCRIPTION OF THE INVENTION

The present invention is directed towards, among other things, non-invasively capturing data on-line and in real-time as the data is entered or operated on by one system and for loading or extracting data from one ore more systems based on the analysis of the captured data flow. Embodiments of the present invention are instrumental in communicating and sharing information between various computer systems and equipment systems.

Aspects of the present invention can be embodied within a computer software system. Such an embodiment may consist of two components. A first component is a computer communication program P. A second component is a computer program Q that can be programmed to act on the information gathered by P and then takes appropriate actions. Capturing of the flow between programs in a network can be done by programs such as P or commercially available systems and/or programs such as sniffer programs (e.g., Sniffem or Colasoft). The two components P and Q are logically separate entities, but can exist as parts of the same program. The combination of P and Q, or sub-components of either P and/or Q are collectively referred to as a non-invasive interface engine.

The computer communication program P includes two sockets which are referred to for purposes of discussion as P(S1) and P(S2). The IP addresses of both of these sockets are the same, namely the IP address of the computer on which the program P executes. However, the ports of these sockets are different. As mentioned before, a socket is bi-directional in that it can receive as well as send information bits.

Turning now to the figures in which like elements are represented by like numerals and labels, various aspects and advantages of the present invention are described.

Returning to FIG. 1, a front-end process 112 communicates with a back-end process 122 over a connection using sockets. The connection includes a From-Socket 114 and a To-Socket 124. FIG. 4 is a block diagram illustrating the employment of the present invention within the simple environment illustrated in FIG. 1. In FIG. 4, the front-end process 412, communicates with the back-end process 422 through the program P 451 running on a computer system, 430, that is interposed in between system 410 and system 420. The program P 451 includes two sockets P(S1) 434 and P(S2) 436. The program P 451 relays whatever information it receives on the socket P(S1) to P(S2) to be sent to the To-Socket 424 of system 420 and whatever it receives on the socket P(S2) to P(S1) to be sent to the To-Socket 414 of system 410. The front-end process 412 and the back-end process 422 are components of the same application system. Program P 451 is non-invasive to the systems that execute front-end process 412 or the back-end process 422, but rather, is intervened between the components of the same application.

The To-Socket of the front-end process 412 is set to P(S1) 434. The To-Socket of program P 451 is set to the socket 424 of back-end process 422. When the front-end process 412 initiates a request for a connection, it sends the request to P(S1) 434. The program P 451 receives the request via socket P(S1) 434 and bridges the request bits to P(S2) 436 (i.e., the program P 451 relays the request-information-bits from the socket P(S1) 434 to the socket P(S2) 436). The To-Socket of P 451 is socket 424 of process 422. When program P 451 receives the acceptance reply from the back-end process 422 via socket P(S2) 436, it relays the acceptance request to the socket 414 of process 412 through P(S1) 434. Thus, the single connection 101 illustrated in FIG. 1 is replaced by two connections 401 and 402 in FIG. 4 with program P 451 acting as a relay.

The connection between P(S1) and P(S2) is through the code embedded in program P 451 that acts as a relay bridging P(S1) and P(S2). In operation, the code copies what is coming to P(S1) over to P(S2) and vice-versa thereby creating a bridge 453. As described thus far, the program P 451 is a pass-through agent and as such, is non-invasive. Thus, there is no need to alter the front-end process 412 or the back-end process 422. Rather, the front-end process 412 and the back-end process 422 continue to operate in the same as they did prior to interposing the program P 451 between them. The only change that is necessary to implement this embodiment is to change the socket parameter of the front-end process 412 and set the socket parameters for program P 451. Even though it is shown that the program P 451 runs on a different computer system 430, it should be understood that the program P 451 does not have to run on a separate computer and could run on either system 410 or system 420.

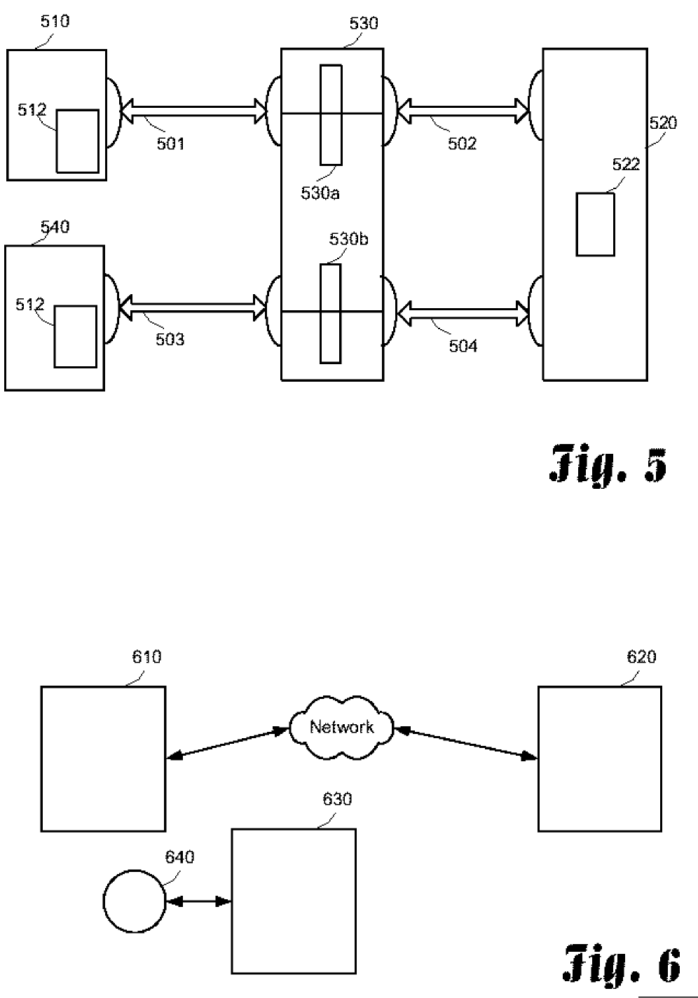

FIG. 5 is a block diagram illustrating two instances of a front-end process 512 running on two different systems, a first system 510 and a second system 540. Each instance of the front-end process 512 communicates with a back-end process 522 running on system 520. The communication with the back-end process 522 is routed through computer program P 530. The first instance of the front-end process 512 running on system 510 communicates with the back-end process 522 over connections 501 and 502 via program P 530. The second instance of the front-end process 512 running on the second system 540 communicates with the back-end process 522 over connections 503 and 504 via program 530. In FIG. 5, two logical instances of the program P 530 are shown. One instance of program P 530a for communication relating to the front-end process running on the first system 510 and the other instance of program P 530b for communication relating to the front-end process running on the second system 540. In the literature, these logical instances are commonly referred to as threads.

The program P 530, rather than being a pass-through program can be enriched to do additional functions. For instance, the program P 530 could be enriched to store the information that it is receiving and sending within its storage space. The information that is being gathered by program P 530 can be sent to another computer system with or without modifying the data. The transmission of the data by program P 530 can be conditional, based on one or more defined circumstances. In addition or in the alternative, the information that has been gathered by program P 530 can be used to train a program to act like an operator performing the tasks of extracting and inputting data.

The Non-Invasive Interface Engine

As mentioned above, the interface engine can include two components. The operation of program P for the reception and transmission of information has been described. In addition to program P, a program Q may operate to take certain actions on the information gathered by P. It should be appreciated that although these two components are described as separate programs, they could also be parts of the same program, such as different modules or processes that run within the same program. An example of an action that program Q may perform is to send some or part of the information gathered by program P to another system. Another example of an action would be sending a warning message to a front-end process under certain circumstances in a manner that does not require having to modify the existing front-end or back-end processes. It should be appreciated that the interface engine, consisting of program P and/or program Q can run on a dedicated system, the system housing the front-end process, the system housing the back-end process, or a combination of two or more of these systems.

Recalling the example scenario provided in the background section, the problems associated with the use of a registration application were described when a new system was employed by a user. FIG. 6 is a block diagram of an environment that does not employ the present invention for the sharing of data. The registration application runs on a first system 610 in conjunction with the front-end process running on the first system 610 and the back-end process running on a second system 620. A third system 630 is a new system that operates to report information to the Public Health Agencies. The third system is controlled by an operator 640 who is responsible for keying in the appropriate registration data and information. The third system 630 is not attached to the network including the first system 610 and the second system 620. As described in the background section, this configuration is plagued with problems.

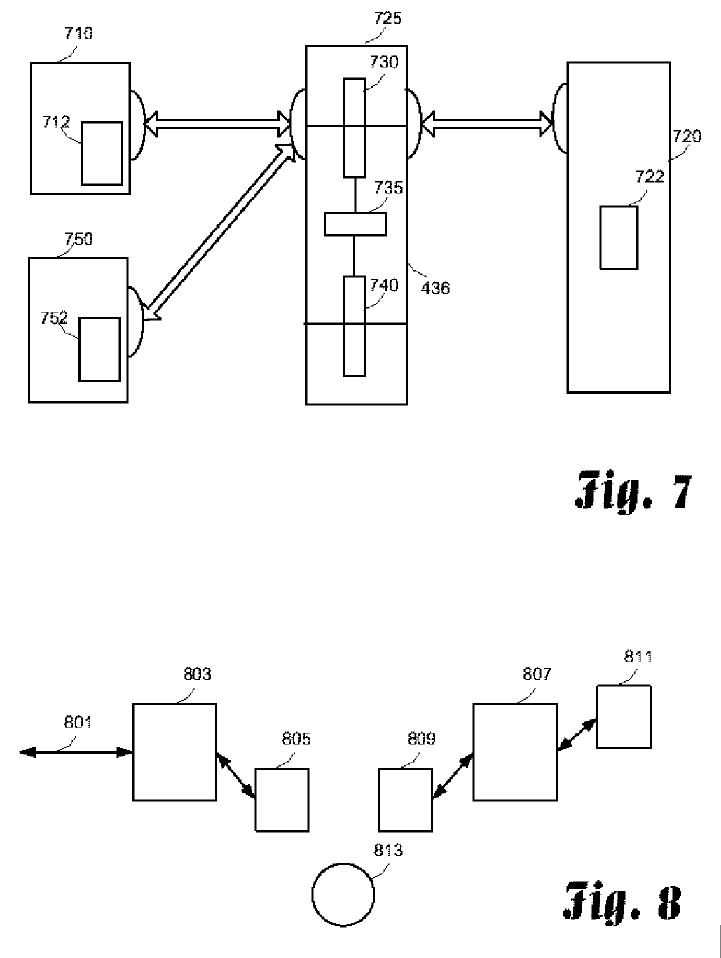

FIG. 7 is a block diagram that incorporates aspects of the present invention to solve problems associated with the configuration of FIG. 6. An embodiment of the present invention, referred to as the Operator Simulation Non-Invasive Interface Engine (OPSNIIFE) 725 is interposed in the communication path between a first system 710 running a front-end process 712 and a back-end system 720 running a back-end process 722. The program P 730 within the OPSNIIE 725 operates to capture registration information that is entered into the first system 710 using the front-end process 712. The program P 730 operates to store the captured registration information into the flow in storage 735. The program Q 740 examines the captured information and determines whether the information needs to be sent to the new system 750 that reports information to the Public Health Agencies. If the information should be sent to the new system 750, program Q 740 makes any necessary conversions to the data prior to sending the data to the new system 750. It will be appreciated that the OPSNIIE 725 can be incorporated directly into vendor equipment. Advantageously, this level of integration enables vendors to sell and market their systems to customers that would not normally be considered for potential sales due to the fact that they have already purchased equipment from another vendor that is not compatible with the vendor's equipment. Thus, OPSNIIE 725 improves vendor equipment to be compatible with already purchased systems. As stated earlier, P 730 and Q 740 are logical functions that could be embedded in the same program without the need for storage 735.

It should be noted that program Q 740 can be coded using examples of data that have been captured by program P 730. In the example provided, the operator may input registration data for a sample patient, (e.g. Roger McLean, date of birth 01.11.1981, sex M and diagnosis Congestive Heart Failure). The data captured by program P 730 may look like the following: !!!!Roger McLean @@@@@@01111981%% M <<<<<<<<<Congestive Heart Failure#333333333333##########.

Program Q 740 can parse this data string and observe that the name appears between control strings !!!! and @@@@@@, that date of birth appears next and is before the control string %% etc. By working with one or more known example input data, program Q 740 can extrapolate the stored data which is the data that is being captured in the flow between 712 and 722. Control characters are those characters that help in the presentation of the information on the screen, such as color, font, font size, etc. The control characters also help in managing the speed of the flow. Using this technique, the format of received data can be identified. For instance, in an electronic form, each of the fields is programmed with known information. The Program Q 740 can then parse the electronic form to identify where each data item is located in the information stream. Once this is done, a template pertaining to the particular electronic form is created. Subsequent completions of the electronic form can then be compared against this template to identify the information in the form.

Thus, two aspects of programs P and Q are (i) that they are monitoring the flow between the components of an application system and (ii) that they are non-invasive in that no changes either to the systems that execute the components or to the components themselves need be made. The application system has been described as being a single application with the components being the front-end and the back-end processes of the application. However, it should be appreciated that the application system can actually be any of a variety of configurations, including but not limited to the following examples:

The application system including a computer and a printer, the computer operating as one component and the printer operating as a second component.

The application system including a computer and a virtual printer or a computer emulating a printer.

The application system including a computer and a storage device.

The application system including a computer and a peripheral device.

The application includes two completely independent application programs that communicate with each other.

The application system including a computer and a monitor, display device or a dumb terminal.

Example Scenarios

Many hospitals purchase and utilize a system called the Pharmacy Information System (“PIS”) for entering and managing medication (drug) information of patients. A pharmacist typically is responsible for entering and managing this information. In this context, the back-end process provides the main functionality of the PIS and front-end process is an application executing on a computer that accesses the medication information of patients and does the presentation. Clinicians (usually, physicians or nurses) prescribe the medication to be given to patients. When providing a prescription for a patient, the written prescription can be faxed to, or scanned into and sent from a computerized order entry system to the pharmacy. When prescriptions are delivered in this manner, the receiving system usually employed is the Pharmacy Order Management System (“POS”). Some examples of typical POS's include POMS from Integrated Informatics Inc, Pyxis Connect from Cardinal Corporation, Meds Direct from McKesson Corporation and Omnilink from Omnicell Corporation. Examples of PIS systems include those available from McKesson Corporation, Siemens Corporation, Meditech Corporation, Cerner Corporation and Mediware Corporation.

FIG. 8 is a block diagram illustrating the interaction of a POS and a PIS for receiving and placing prescription orders. The illustrated system includes a front-end process of the PIS 807 and a back-end process of the PIS 811. The front-end process 807 displays information to a user through 809 which is usually a monitor. The POS operates on a computer system 803 that includes a display monitor 805 and a prescription reception interface 801 that can receive prescriptions via a facsimile, scanner, computerized order entry system or any of a variety of other input systems and/or devices. A pharmacist or other user 813 enters data into the PIS system and verifies the data entry by examining the displays 805 and 809.

To enter an order into the PIS, the pharmacist enters the patient identification information, such as a unique patient number into the PIS front-end 807 at which time the patient order entry screen is displayed on the monitor 809. To enter the order information, a pharmacist needs to bring up the prescription information on POS for the corresponding patient. One way to accomplish this to have the pharmacist enter patient identification information also on the POS. This approach of entering the identification information lowers the productivity of pharmacists and is also error prone due to possible transposition of identification information or the introduction of typos. The PIS and POS systems use the same common data element, namely patient identifier, to identify an order requisition. In a multi-hospital healthcare system, other data elements such a hospital identifier could also be associated with the patient identifier common data element.

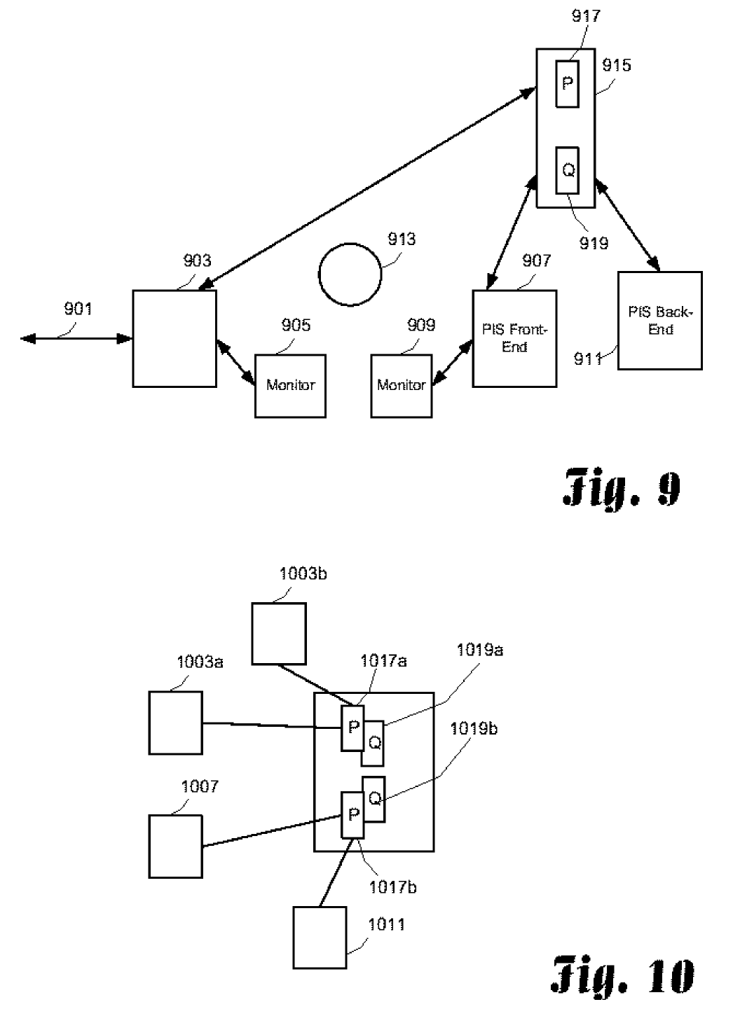

FIG. 9 is a block diagram illustrating the incorporation of aspects of the present invention to alleviate the problems with regards to sharing information between the PIS and POS scenario. Aspects of the present invention are incorporated into an OPSNIIE 915 which is interposed between a front-end system running a front-end process 907 of the PIS and a back-end system running a back-end process 911 of the PIS. Program P 917 running within the OPSNIIE captures the flow of data, information, operations, etc., between the front-end process 907 and the back-end process 911 and then stores the data, information, operations, etc. into memory storage. The program Q 919 running within the OPSNIIE constantly monitors the information and data that is being captured and/or stored by program P 917. Certain types of information will trigger the program Q 919 to take various actions. For instance, when program Q 919 detects information indicating that a pharmacist is providing patient identification information entries into a new order entry screen in the PIS, it captures the identification information. The program Q 919 may then operate to (1) send the captured information to the POS in a manner that simulates being a user of the POS, and (2) inform the POS that an order requisition has been entered through sounding an alarm or buzzer, and/or providing a pop up window on the POS monitor, and/or any other form of notification to indicate that order requisition has been entered. Sending the captured data to the POS and simulating a user of the POS involves placing the information into a format that the POS already expects. Such formatting can include, but is not limited to, providing key stroke simulations, providing HTML data entry and selection simulations, and/or providing straight commands with appropriate parameters. If there are more than one order requisitions for the same patient, the POS may be programmed to process the order with the highest priority or, it may simply process the order requisitions in a first-in-first-out manner. When the POS receives the patient identification information, the corresponding order is popped up onto the screen of the POS to gain the attention of the pharmacist. Thus, without requiring any modification to the PIS or the POS, the entry of the patient identification on the order entry screen in the PIS is automatically entered into the POS which pops up the corresponding order attracting the attention of the pharmacist. The pop-up aspect of the invention advantageously notifies the pharmacist of the requisition order that he entered without his participation or knowledge. Further advantages of the automatic synchronization and pop-up aspects of the present invention are that they cooperate to increase the productivity of the pharmacists and reduce the likelihood of operator errors during the data entry of a new order—thus increasing patient safety.

The systems along with OPSNIIE can also be structured so that when an order is opened in POS, a request for the order entry screen for the corresponding patient is sent to PIS and subsequently, the requested order entry screen is popped up on the PIS monitor automatically.

Another PIS and POS integration scenario that is suitable for an embodiment of the present invention arises when a PIS user wants to gain access to an original prescription order in the POS. For instance, when a pharmacist enters an order into the PIS, the PIS generates an order number that is used to identify and track this order. Subsequently, if a concern is raised regarding the type of medication that was given to a patient, the dosages, etc., the order in the PIS corresponding to the order number is analyzed. At that time, it may be beneficial to retrieve and analyze the original order that was prescribed by a clinician. The original order resides in the POS. In the past, a technique to handle this issue was to have the pharmacist who entered the order in PIS remember the PIS order number and then enter this number into the POS system thereby associating the order number and the corresponding order requisition. Normally, the pharmacist performs the step of entering the PIS order number into the POS just after confirming an order in PIS. Operating in this manner results in increasing the work load for the pharmacists, lowers the productivity of pharmacists and increases the likelihood that errors can be introduced. Traditional Interface Engines offer no benefit to resolving this situation. In this scenario, the order number is the common data element.

In FIG. 9, the program Q 919 of OPSNIIE 915 was described as constantly monitoring the information and data that is being captured and/or stored by program P 917 of OPSNIIE 915 and that the OPSNIIE 915 can be interposed between the front-end of the PIS and the back-end of the PIS. When program Q 919 detects that a pharmacist is confirming an order for a patient, program Q 919 operates to capture the order number and then sends the order number to the POS. The POS can associate the PIS order number with the corresponding order requisition. This automatic feature increases productivity of pharmacists and makes the operation less error prone increasing patient safety.

Another PIS and POS integration scenario that is suitable for an embodiment of the present invention arises where a pharmacist is forced to multiplex between two or more patients. For instance, while a pharmacist is working on an order for a first patient, the order requisition for the first patient is displayed on the monitor screen 905 interfacing to a POS 903 and the order entry screen for the first patient is displayed on the monitor screen 909 of a PIS. At this point, the pharmacist is ready to place the order. Placing an order for a patient on the PIS is a somewhat involved process and thus, it can take several minutes. The pharmacist needs to make sure that: (a) the medication that he or she is entering for the patient is available in the pharmacy (if not, the pharmacist substitutes the medication that was ordered with an equivalent medication and adjusts the dosage), (b) the medication that is ordered will not adversely react with the medications that the patient is currently taking, and (c) the patient is not allergic to the medication that is prescribed. While performing the work on an order, such as the order for the first patient, it is fairly frequent that the pharmacist will receive a call from a clinician regarding a second patient. Most likely, to answer any questions posed during the telephone call regarding the second patient, the pharmacist will be required to navigate the menus and screens of the PIS to pull up a list of the medications for the second patient onto screen 909. When the conversation between the clinician and pharmacist ends, rather than clearing the second patient's information from the screen 909, it is quite possible that the pharmacist will inadvertently enter the medication information for the first patient displayed on monitor 905 of the POS 903 for the second patient which displayed on monitor 909 of the PIS. This situation can arise quite frequently and the results can be detrimental to the patient.

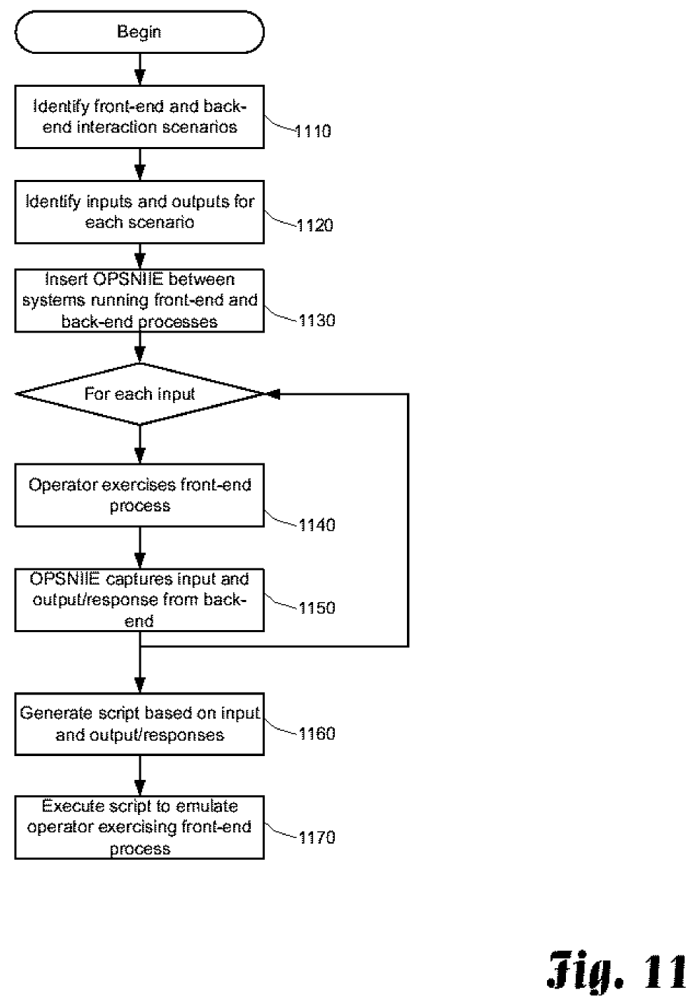

FIG. 10 is a block diagram incorporating aspects of the present invention to alleviate the problems associated with the incorrect entry of data across the PIS and POS platforms situation. The front-end process 1007 of the PIS and the back-end process 1011 of the PIS communicate through program P 1017b which is interposed between the two. The front-end process 1003a and the back-end process 1003b of the POS system have program P 1017a interposed between them. P is shown as two separate instances; however, those skilled in the art will appreciate that this could be handled with a single instance of the program P . . . When the program Q 1019b detects that the pharmacist is confirming an order for a patient, it can compare the patient identification information that the program P 1017b has captured and the patient identification information that the program P 1017a has captured. If the comparison results in the identifications being different, the program Q 1019b can inform program P 1017b not to forward the confirmation command to the back-end 1011, and rather, to send alert information to the front-end, 1007. The common data element in this scenario is the patient identification number.

Script Driven Engine

Another aspect of the present invention is a script driven engine. As has been previously mentioned, it may be necessary to transfer information from an existing system, such as a registration system, to another system in electronic format. Within the context of a hospital, the registration system is often referred to as admissions, discharge, transfer system (“ADT”). In physician offices, this system is often referred to as physician practice management system (“PPMS”). A few examples of ADT systems that are available in the market are those offered by Cemer Corporation, McKesson Corporation, Siemens Corporation and Meditech Corporation. A few examples of PPMS systems that are available in the market are those offered by Medical Manager System from WebMD Corporation and Medic System from MiSys Corporation. The information content that is of interest in these systems is rather simple. In the registration systems, the information of interest consists of patient demographics, insurance data, next-of-kin data, physical location of the patient, physicians associated with the patient and the diagnostic information.

In physician offices, clinical records for a patient are typically stored in an Electronic Medical Record System (“EMR”). These systems store clinical information such as laboratory, radiology, history and physical reports pertaining to patients. Examples of EMR Systems include those provided by Allscripts Corporation, General Electric Corporation and Epic Corporation. It is often advantageous to access information from an EMR to conduct trend analysis.

Users of the systems are able to retrieve or store information from or to the registration system through various operator screens. However, users would like to have access to this information in an electronic format as well. For example, a physician may be interested in getting a list of patients who are 70 or more years of age so that he or she can send specific and pertinent information to the patients either through automated telephone calls or via email. An another example is where the information within the registration system is also needed in electronic form for use by the Pharmacy Order Management System (POS) installed in hospitals. Pharmacy order requisitions created by the hospital staff generally include the patient's identification number. The POS recognizes the patient identification number using a scan of a bar-coded label or by reading the indentations imprinted by an addressograph gadget just like credit-card imprints. When the recognition fails, the pharmacists can also enter the identification number manually. When the POS recognizes the patient identification number or when a pharmacist inputs the patient identification information into the POS, it would be greatly beneficial if the POS system could automatically fetch the other information related to the patient from the registration or ADT system. It would also be greatly beneficial if the POS could gain access to the electronic information regarding the medications to which the patient is currently prescribed. This information is available in the Pharmacy Information System PIS.

This aspect of the invention relates to implementing a scripting program that is operative to extract data from a system or input data into a system, without requiring cooperation from the system vendors and without invasively changing any computer programs installed in the user's environment or without installing any new programs in the said system. The scripting program uses the knowledge captured by OPSNIIE. The data that is of interest and that is stored in the information management systems is typically accessible to users through an operator or user interface provided by the system vendor. For example, the registration information from an ADT or PPMS systems are retrievable by providing a patient identification number, such as the medical record number or the patient's Social Security Number. The medications currently prescribed for a patient can be retrieved from the PIS by providing the patient identifier, such as the Patient Account Number. Further, additional information regarding the patient can also be entered into the PIS through various input screens that are accessed by providing the Patient Account Number.

When an operator accesses such a system, the operator engages the user interface and performs various actions, receives responses and prompts and gets and/or puts data. The script driven engine aspect of the present invention operates to imitate these actions of an operator. Advantageously, this aspect of the present invention provides access to the data within a system without having to know the specific data formats in which the data is stored or without having to create customized programs to be placed in the system to extract this data. Placing a program in the system will be an invasive approach.

The actions of an operator accessing a system can be viewed as a series of instructions and responses (i.e, can be easily represented in a script). The script driven engine basically imitates the scripted instructions that the operator would perform manually. The script driven engine is constructed in such a manner that it understands connectivity, variables and constants. The script driven engine is capable of requesting a connection, listening and/or capturing data that is transmitted through a socket and operable to send data through a socket. The script driven engine is also capable of performing certain defined actions (also called commands or operations or verbs). Example of such actions include:

Send Variable

Expect Constant

If variable=constant then go to label XYXXY

Capture input stream into variable

Write variable into file

The script driven engine runs by reading and interpreting actions provided in a script. A script consists of statements defining variables, constants and actions. The engine reads a statement from the script and then executes the action stated in the statement. For example if the statement states Send Constant “Peterson\r\n”, the engine will send the constant Peterson followed by carriage return and line-feed characters over the connection. The action “Send Constant” is interpreted by the engine to send the constant that follows the Send Constant command through the socket. Similarly, the action “Send Variable V” is interpreted by the engine to send the value associated with the variable V through the socket.

FIG. 11 is a flow diagram illustrating the steps involved in defining or creating a script for the script driven engine. The first step 1110 is to analyze and understand various scenarios in which the front-end process and the back-end process interact. Examples of such scenarios that must be addressed include, but are not limited to:

(1) Identifying what the back-end process returns to the front-end process in response to entering a patient identification as input to the system for a patient who is not present in the database

(2) Identifying what the back-end process returns to the front-end process when the back-end process is too busy to respond to the front-end

(3) Identifying what the back-end process returns to the front-end process under normal operation when the front-end process provides a proper identification number

(4) Identifying what happens when the front-end process requests information and back-end process is currently unavailable or down.

The second step is for an operator to identify inputs for each of the scenarios and get outputs in human readable form 1120. The third step is to interpose an interface engine such as the OPSNIIE between the respective systems housing the front-end process and back-end process 1130. For each scenario and each set of inputs, exercise the front-end and back-end interaction by entering the values 1140. For each input value, the output or response is captured by the program P running within the OPSNIIE 1150. Then the data gathered from the program P is analyzed with the human readable inputs and outputs that were gathered in the second step.

Based on this analysis, a script file can then be constructed 1160. The script file can then be executed to emulate operator actions 1170. Table 1 illustrates a script that can be created using the procedures outlined in FIG. 11 based on capture of the flow in a registration application between an operator and the application.

The script can be created in a variety of manners including a manual creation by combining data elements extracted from the system into a script file, or by merging or combining the data elements into a script file template or script file form. This latter technique could be accomplished by a software program. Thus, in one embodiment, an executable script file containing all necessary information can be created. In another embodiment, a script file template can be created where the script file template includes instructions, data elements and placeholder for additional data elements or values that can be provided at execution time. It should be understood, that the terms script file and script file template can be used interchangeably. In addition, a script file and a script file template can be used in a similar manner.

When the script driven engine executes the script, the script driven engine causes several events to occur. First, the script driven engine logs-on to the application by sending Logon Id and Password. The script driven engine then reads the Medical Record Number of a patient from a file and sends the Medical Record Number to the application. The information received from the application is then captured. The captured text is examined to see if any error conditions were encountered and if so, an error code is prefixed to the text string. The text string is then written into a file. It should be understood that the example script file in Table 1 has been simplified for purposes of conveying an example. The commands (key words) are shown bold in Table 1. Additional operations and features can be included in the script file, such as control characters. In Table 1, each line is a statement. A statement that starts with /* and ends with */ is a comment statement that explains the meaning of the next actionable line. The comment statements are included for adding clarity.

The script driven engine can be a stand alone program or it can be embedded within another program as a function call, a terminate-and-stay resident program, an interrupt routine, or a background process. When operating in conjunction with another program, the script driven engine can receive inputs from the other program, execute the inputs, and then provide the results to the invoking program. It can also be imbedded in another program, D, where the program D gives the inputs to the engine and the engine returns the required information to D.

Miscellaneous Observations

Although the various aspects of the present invention have been described primarily in the context of fetching or retrieving information and data from a system, it should be understood and appreciated that the various aspects of the present invention are also applicable for pushing or writing data into a system. An exemplary environment in which the pushing or writing capabilities of the present invention are illustrated is within the use of a browser enabled front-end process. For instance, suppose that a registration application has a browser-enabled front-end process through which an operator accesses the system. The browser could be any commercially available browsers such as Netscape or Internet Explorer, as well as any other similar PC based or handheld device based browsers. Such applications may be installed in hospitals to allow patients to pre-register using their home or office computers and access the registration system through a browser.

Prior to releasing or launching such a product, the hospital will most likely do extensive testing with various appropriate and erroneous input to verify that the system will not crash or that it cannot be hacked into. It is customary in the industry to keep the test steps that were performed in a file and exercise these test steps each time a newer version of the product is released. This will insure that the newer version continues to perform the earlier versions of the product. Exercising the test steps can be automated by a script driven program.

The script driven engine aspect of the present invention is quite suitable for such a situation. A test program can be constructed that will take different test steps from a file and exercise the application for different test step inputs. First, the connection between the front-end process, the browser application, the back-end process, and the registration system, can be routed through an OPSNIIFE. Then the operator can input various test data. The flow between the two processes can be captured and used to generate a script. When a newer version of the product is ready to be tested, a test program using an engine that uses the script can automate the testing.

The script driven program operates on a script that was based on the data captured between a front-end and a back-end process. As mentioned earlier, capturing of the flow between programs in a network can be done by programs such as OPSNIIE or commercially available network sniffer programs such as Sniffem or Colasoft.

The various aspects of the present invention, including the OPSNIIE and the script driven engine have been presented in the context of sockets, front-end processes running on a computer and a back-end processes running on another computer. It should be appreciated that the OPSNIIE can also be used in application environments that are based on the use of dumb terminals. Examples of dumb terminals include VT200-like terminals, terminals from Data General and the like, and variations of ASCII terminals. These terminals are driven by a central computer and have very little built-in intelligence. Dumb terminals are connected to the central computer through a serial RS232 port or similar communication interface.

In an embodiment utilizing dumb terminals, the OPSNIIE can be loaded onto and execute on a personal computer. The personal computer will include two physical serial ports. Most of the personal computers usually have one serial, one parallel, one game and one USB ports. However additional serial ports can be added by installing a serial port board or through an external expansion such as the serial port boxes available from CompUSA. A dumb terminal that would normally be connected to the server equipment housing the application is instead connected directly to one of the ports of the computer housing the OPSNIIE. The other serial port of the computer housing the OPSNIIE is connected to the server equipment housing the application. Thus, by looking at FIG. 7, in this embodiment the computer 710 can be a dumb terminal, a dumb terminal emulator or a browser based program. The OPSNIIE runs on the computer platform, 725. The application 722 being accessed by the dumb terminal 710 can be housed on server equipment 720. Program P running in the OPSNIIE bridges the two serial ports and captures the flow of data and information. A script can be derived based on the analysis of this flow. The script driven engine driven by the script will imitate an operator working on the dumb terminal and the back-end process will be unaware that it is being executed by a script driven engine rather than an actual user.

It is appreciated that programs based on a script driven engine can only work in an environment in which the interaction between the underlying system and operator is stable. Any changes in this interaction can result in a failure of the script driven engine. If the underlying system and operation interaction changes, for the script driven engine to continue operating, new data must be captured, analyzed and the original script (not the Engine) needs be modified. As an example, if the script was written based on a flow captured using an operator using VT200 terminal and if the underlying system will not support such terminals in its later versions, then the script becomes obsolete. However this situation is not different if the programs were written based on the formats of the messages between systems and there is a change in the message formats of one or more of the underlying systems. And this situation is not different if translation programs were written based on accessing a database and there is a change to the database structure. Typically, changes to the interactions between an operator and the underlying system are not quick implementations. Most such changes are performed in a “test area” where the operators will be trained. At that time, OPSNIIE can be used to capture the flow between the “test areas” and the captured knowledge can be used to modify the scripts before the modified product is introduced to the market.

Even though the discussions have been in the context of getting or putting data from a terminal, the concept of OPSNIIE is equally applicable by having OPSNIIE simulate an operator or a printer. As an example, in a computerized physician order system (CPOE), physicians enter orders such as drug prescriptions or laboratory tests using a computer. The orders entered by physicians are meant to be sent to various clinical systems, such as a PIS, which requires interfacing between the CPOE system and the clinical systems. It is not uncommon, that in several hospitals the orders entered are printed out on paper and re-entered by clinical professionals into the clinical systems. Hospitals use this method as a first step towards full integration while eliminating the errors in having physicians write paper orders. By having a virtual printer installed in a computer and placing OPSNIIE between the virtual printer and the CPOE system, there would be no need for printing the orders. The print images of the orders are captured electronically. Print images can also be retrieved from printer spoolers. The print images are then parsed and analyzed. OPSNIIE's operator emulation technology can then be utilized to enter the orders into the respective clinical systems. In this example, OPSNIIE interacts with the components of the CPOE system and also with the clinical systems.

When medications are administered to patients, information indicating what medications were given to what patient and by whom, along with the dosage and method how the medications were administered, are recorded. These records are referred to as Medication Administration Records (“MAR”). MAR forms for patient are produced by PIS, the pharmacy information system. The form will have information of a patient (demographics, room number where the patient is located, allergies for the patient etc.), scheduled medications (name of the medication, dosage, route and time of administration) that the patient were to be given and unscheduled medications (for example, give Aspirin if patient is under pain) that the patient might be given. In many healthcare institutions, such forms are printed in paper once a day by the pharmacy and are distributed to nurses. Nurses make the entries in the paper forms manually. Completed forms get filed with the patient's chart. Copies of the completed forms are also sent to pharmacy for reconciliation and to the billing department for doing the billing. To increase the productivity of the pharmacists and nurses and to reduce errors, computerized MAR Systems are being introduced. Cemer Corporation, McKesson Corporation and others offer such products.

A major impediment is deploying such systems is the issue of interfacing the MAR System with other existing systems. For example, PIS should be interfaced with the MAR System to send the data that are in MAR forms. Using the approach outlined above, OPSNIIE can take the data from a virtual printer that PIS prints to and enter the data into the MAR System avoiding an expensive and time consuming interface between PIS and MAR.

When a new MAR entry is made or an existing MAR is modified in the MAR System, the pharmacy information system PIS and the billing system need be notified periodically. MAR records are periodically printed and the printed data are entered by clinicians into the PIS system and the billing system. Using the virtual printer approach outlined in the previous paragraphs, OPSNIIE can be deployed to automate the process of sending information from a MAR System to a PIS System and from a MAR System to a billing system.

In summary, the various aspects of the present invention are based on capturing the flow of operations between an operator and a computer system, or one computer system with another. One aspect of the present invention focuses on capturing the flow real-time and then using the captured information for other purposes. Another aspect of the present invention focuses on analyzing the captured flow to derive a script, which could then be used by a script driven engine to simulate an operator. The application of these and other aspects of the present invention have been described in relationship to healthcare information systems. However, those skilled in the art will appreciate that the utility of the various aspects of the present invention includes the ability to extend the existing systems in a non-invasive manner and without requiring any help from the system vendors.

The present invention has been described using detailed descriptions of embodiments thereof that are provided by way of example and are not intended to limit the scope of the invention. The present invention can be implemented as a process that runs within a variety of system environments or as an entire system including various components. The described embodiments comprise different features, not all of which are required in all embodiments of the invention. Some embodiments of the present invention utilize only some of the features, aspects or possible combinations of the features or aspects. Variations of embodiments of the present invention that are described and embodiments of the present invention comprising different combinations of features noted in the described embodiments will occur to persons of the art.

TABLE 1
/* UID is a variable and is initialized to a constant value Peterson */
Variable UID = “Peterson”
Variable Password = “John”
Variable Socket = “192.1.84.105; 9122”
/* MRN is a variable and it is not initialized to any value */
Variable MRN
Variable Info
Variable Inpfile = “c:\inputfile.txt”
Variable Ofile = “c:\Outputfile.txt”
/* Each of the following statements perform an action */
/* Each statement has a line number followed by action */
/* Send the connect command to the socket address */
10 Connect-To Socket
/* If an ACK is received within 10 seconds, go and execute the next
line, else go to label
On Timeout:
20 Expect “ACK” Timeout 10 secs
/* Send the content of the variable UID followed by constant carriage
return and line feed
over the connection */
30 Send UID + “\r\n”
/* If the reply “Enter Password:” is received within 15 seconds, go
and execute the next line, else go to label On Timeout: */
40 Expect “Enter Password:” Timeout 15 secs
50 Send Password + “\r\n”
60 Expect “Enter MRN:” Timeout 15 secs
70 /* Read the content of the file whose name is in the variable
InpFile into a variable MRN */
80 Read From File InpFile into MRN
90 Send MRN + “\r\n”
100 /* Assume the Registration Application returns patient information
followed by constant “<NEXT>” */
110 /* Capture the data returned into a variable info until the
constant <NEXT> arrives */
120 /* if <NEXT> does not arrive in 20 secs, go to label On Timeout */
130 Capture Into info until “<NEXT>” Timeout 20 secs
140/* if info contains the phrase “Patient Not Found”, prepend an
error message to

variable info */

150 If info Contains “Patient Not Found” Set info = “ERROR.
UNKNOWN PATIENT “+info
160 Write info into File Ofile
170 /* logoutlabel is a lable for line number 160”
180 logoutlabel:
190 Send “Logout\r\n”
200 Expect “Logged Out”
210 End
220 /* On Timeout is a label */
230 On Timeout:
240 /* Linenumber is a system variable that contains the line
number where the time out occurs”
250 Write “Error” + Linenumber into File Ofile
260 Go To logoutlabel:

What is claimed is:

1. A non-invasive interface engine for enabling the sharing of data between a first application system and a second application system, the first application system including a first component and a second component that are communicatively coupled to each other, the apparatus comprising:
a first interface for capturing information signals passing between the first component and the second component of the first application system;
a second interface for providing data elements in a manner compatible with the second application system to the second application system;
a processing unit operable to:
identify pertinent data elements in the information signals passing between the first component and the second component of the first application system, the pertinent data elements being data elements that are common between the first application system and the second application system; and
provide the data elements to the second application system.

2. The non-invasive interface engine of claim 1, wherein the first component and the second component of the first application system are physically separate components and the first application system interface includes a separate interface to the first component and the second component and the information signals pass through the non-invasive interface engine.

3. The non-invasive interface engine of claim 1, wherein the processing unit is operable to format the pertinent data elements into a format compatible with the second application system by merging the data elements into a script file to control the interface to the second application system.

4. A system sharing data elements between a plurality of application systems, the system comprising:
a first application system including a first component and a second component communicatively coupled to each other;
a non-invasive interface engine that captures information signals passing between the first component and the second component;
a second application system that is communicatively coupled to the non-invasive interface engine;
the second application system and the first application system operating on at least in part on a set of common data elements;
a processor that is operative to:
identify pertinent data items in the information signals captured by the non-invasive interface engine; and
providing the pertinent data items to the second application system in a manner compatible with the second application system.

5. The system of claim 4, wherein the first component of the first application system is a front-end process of the first application system and the second component of the first application system is a back-end process of the first application system.

6. The system of claim 4, wherein the first component is an application running on a computer and the second component is device selected from the set of devices including: a virtual printer, an actual printer; a database, a storage device, a display device, a peripheral device or another computer.

7. The system of claim 4, wherein the processor is operative to provide the pertinent data items in a manner that is compatible with the second application system by formulating interface commands that are compatible with the second application system.

8. The system of claim 4, wherein the processor is operative to provide the pertinent data items in a manner that is compatible with the second application system by merging the pertinent data into a script file to control the second application system.

9. The system of claim 8, wherein the processor is operative to provide the pertinent data items by being further operable to execute the script file.

10. The system of claim 4, wherein the application systems are a pharmacy order management system and a pharmacy information system.

11. The system of claim 4, wherein the first component and the second component of the first application system are respectively a front-end and back-end of an admission, discharge, transfer, status management system.

12. The system of claim 4, wherein the first component and the second component of the first application system is respectively a front-end and back-end of a physician office practice management system.

13. The system of claim 4, wherein the first component and the second component of the first application system are respectively a front-end and back-end of a physician office electronic medical record system.

14. The system of claim 4, wherein the processor is operative to identify pertinent data items by:
comparing the information signals to a template;
extracting data elements from the information signals based on the comparison with the template; and
identifying the extracted data elements as pertinent data items.

15. The system of claim 4, wherein the processor is further operative to:
exercise the first application system with a set of known data;
examine the information signals to identify the known data; and
create a template based on the location of the known data within the information signals.

16. The system of claim 4, wherein the first component and the second component of the first application system is a computer and a printer respectively, and the non-invasive interface engine captures information signals from the output of the computer being sent to the printer.

17. The system of claim 4, wherein the first component and the second component of the first application system is a front-end process and a back-end process of the first application system, and the non-invasive interface engine captures interface commands between the front-end process and the back-end process.

18. The system of claim 4, wherein the first application system is a pharmacy information system and the second application system is a pharmacy order management system and the non-invasive interface engine captures information signals relating to a new prescription order entered into the pharmacy information system.

19. The system of claim 4, wherein the processor is operative to identify pertinent data items by:
receiving definitions of specific data elements to be captured by the non-invasive interface engine;
identifying the specific data elements in the information signals captured by the non-invasive interface engine as pertinent data items;
and the processor is operative to provide the pertinent data items to the second application system in a manner compatible with the second application system by:
formatting the pertinent data items in a manner that is compatible with the second application system; and
providing the formatted data items to the second application system.

20. A method for enabling access to an application system, the application system including at least two components that exchange information signals, the method comprising the steps of:
defining specific data elements contained within information signals that are exchanged between a first component and a second component of the application system;
capturing at least a portion of the defined specific data elements in the information signals during normal operation of the application system;
creating a script file template based at least in part on the captured specific data elements, the script file template comprising instructions and data as well as placeholders that represent operations to emulate an interface with at least one component of the application system;
performing the script file template to emulate the interface of the at least one component of the application system.

21. The method of claim 20, wherein the step of creating the script file template, further comprises including data elements from a source that is external to the application system.

22. The method of claim 20, wherein the first component is a subsystem through which an operator accesses the application system and the script file template, when executed by a processing unit, emulates the operation of the first component interfacing with the second component of the application system.

23. The method of claim 22, wherein the processing unit is an element of a second application system, and the step of executing the script file template comprises the processing unit emulating an interface to the second component of the application system.

24. The method of claim 20, wherein the step of performing the script file template, further comprises substituting the placeholders with particular values.
